(19) United States
(12) Patent Application Publication
(10) Pub. No.: US 2010/0102927 A1
(43) Pub. Date: Apr. 29, 2010

(54) MOBILE IDENTIFICATION DEVICE

(75) Inventor: Stefan Mönig, Schwelm (DE)

Correspondence Address: CANTOR COLBURN, LLP, 20 Church Street, 22nd Floor, Hartford, CT, 06103, US

(73) Assignee: HUF HÜLSBECK & FÜRST GMBH & CO. KG, VELBERT (DE)

(21) Appl. No.: 12/598,683

(22) PCT Filed: Apr. 23, 2008
(86) PCT No.: PCT/EP2008/054888

§ 371 Date: Nov. 3, 2009

(30) Foreign Application Priority Data
May 3, 2007 (DE) 10 2007 021 135.1

(51) Int. Cl. G05B 19/00

(52) U.S. Cl. 340/5.64

(57) ABSTRACT

The invention relates to a mobile identification device (10) of a security system for keyless activation of a closing device of a motor vehicle (40), having a housing (20) and a sensor display (30). An electronic unit with a transmitting and receiving unit is arranged in the housing (20) and communicates with a motor vehicle-side transmitting and receiving unit (41), by means of which an identification test can be carried out for determining a user's access rights. A surface (31) of the sensor display (30) allows the input and the output of information. According to the invention, it is proposed that the mobile identification device (10) has a pen-like input means (50) which allows for the input of information.

### TECHNICAL FIELD OF THE INVENTION

The invention concerns a mobile identification transmitter of a security system for keyless activation of a locking device of a motor vehicle with a housing and a sensor display, wherein in the housing an electronic unit with a transmitting and receiving unit is arranged, which is in communication with a transmitting and receiving unit in the motor vehicle, by which an identification check to establish a user's authorization can be carried out. The surface of the sensor display is for input on one side and for output on the other side.

### BRIEF DESCRIPTION OF RELATED ART

To elevate convenience for the user and for increased theft prevention, locking devices for motor vehicles are often equipped with an electronic operation unit, in particular a mobile identification transmitter. After an appropriate activation by the user, data communication takes place between the mobile identification transmitter and a transmitting and receiving unit that is arranged in the vehicle. In the scope of the data communication, a code is exchanged, preferably over electromagnetic waves. If the code is positively evaluated, the doors or the trunk lid of the motor vehicle can then be unlocked and/or locked by remote control, for example, and other functions can be triggered as well.

In DE 20 2005 015 165 U1 a locking device for vehicles is disclosed, which has a portable key with a sensor display. The sensor display is not only an effective indicator, but can also be used as a keyboard for data retrieval and for controlling locking and/or operational conditions in the vehicle. Such types of sensor displays—also called “touch screens”—often have a display means with a control layer lying over it. The latter can consist of two electrically conductive indium-tin oxide (ITO) layers, for example. Each of the two ITO layers has a strip-type construction, wherein the strips of the two layers are arranged perpendicular to each other. When a user touches the sensor display at a specific place, the two ITO layers come in contact with one another, whereupon an electrically conductive contact is produced. This electrical contact serves to establish the position of the point of contact on the sensor display. So that the key of the remote-control locking device maintains an appropriate size, the sensor display should not be too large. Disadvantageously it has come about that, because of the small size and the number of functions arranged next to each other, operating errors often occur.

### BRIEF SUMMARY OF THE INVENTION

The invention provides a mobile identification transmitter that avoids the above-mentioned disadvantages, in particular, to provide a mobile identification transmitter that has high operational reliability.

The invention provides that the mobile identification transmitter has a stylus-like input means, which input means serves for the input of information.

With the input means, information can be input into the mobile identification transmitter from the sensor display. A user need no longer use his finger, by which the likelihood of error when inputting data is significantly reduced. Furthermore, the density of information displayed on the sensor display can be increased in order thus to enable the user to get a comprehensive overview of the lock state, etc. of his vehicle. By the use of the input means there is no more danger that unwanted information will be input into the mobile identification transmitter and conveyed to the vehicle by an operational error.

In order to further increase the precision of the input, in an advantageous arrangement the input means can have an input tip, and contact between the sensor display and the input tip can enable an input of information. In order to display a multitude of data on the sensor display, the latter can be separated in a number of input areas for each specific item of information. With this arrangement only the size of the input tip determines the needed surface of the input area represented on the sensor display. By touching the sensor display with the input tip the function or information underlying the input area is processed in the mobile identification transmitter. As an example, this can include the request to lock or unlock the motor vehicle. A suitably formed symbol can be displayed in the respective input area and be activated by the input tip of the input means. By the use of an input tip the size of the input means is further reduced, which facilitates a fast and precise input of greater quantities of information into the mobile identification transmitter. Should the quantity of input areas remain constant, however, as a countermove the size of the sensor display and therewith that of the mobile identification transmitter can be reduced.

So that the input means or the input tip does not scratch up the surface of the sensor display, or so that wear and tear does not occur, in a further advantageous arrangement it is provided that the input tip has a soft plastic core. This soft plastic core is in direct contact with the sensor display and transmits the pressure conveyed upon the input means by the user. As the hardness of the sensor display, according to the invention, is greater than that of the input tip, the latter cannot damage the sensor display. Further, any dirt particles can be picked up by the input tip in order to prevent scratching the sensor display. To improve haptic perception, the input means can be fashioned as an input stylus with a soft plastic core. In this, the input stylus can have a hard shaft that is easy to grip, in which the soft plastic core is seated and forms the input tip.

In one possible embodiment the input stylus or the shaft of the input stylus is produced from plastic and/or metal. Plastics have an advantage in this as they are easy to process and have a low specific weight. Consequently, the input stylus designed for the mobile identification transmitter is light and does not represent a cumbersome object for the user. An input stylus that is made partially or wholly from a metal has, in contrast, greater firmness. Preferably, a metallic input stylus can be integrated into the mobile identification transmitter in such a way that it functions as part of a skeletal housing base.

In a further advantageous arrangement, the input means is stored in a receptacle. The intended effect is that the input means is nearly impossible to lose, yet it is stored on or in the mobile identification transmitter, ready to be grasped at any time. A user then need not search for the input means. In addition, the receptacle protects the input means from environmental influences.

Alternatively, the input stylus can be stored in a casing-type receptacle. This alternative assumes that the input stylus has a cylindrical shape. The casing-type receptacle which holds the input stylus can be put on an outer surface of the housing of the mobile identification transmitter. This variant embodiment presents itself especially if the casing-type receptacle is additionally fastened to the housing. This is possible, for example, by gluing, welding, preferably laser welding, friction welding, etc. If, however, use of the input means is planned from the start, the casing-type receptacle for the input stylus can even be placed inside the housing. A corresponding opening in the housing makes it possible for the user to push the input stylus into the casing-type receptacle. Advantageously, the length of the receptacle is approximately equal to that of the input stylus.

A measure improving the invention anticipates that an energy storage mechanism is placed inside the receptacle on the input means, and the energy storage mechanism in one position of the input means pushes this out of the receptacle. A user can thus push the input means into the receptacle and thereby cock the energy storage mechanism. A locking means, which cooperates in a force-fitting and/or form-fitting manner with a counter-locking means arranged on the input means, holds the input means in the receptacle. Preferably, only a short pressing of the input means into the receptacle is necessary to release the connection of the locking/counter-locking means. The previously cocked energy storage mechanism can then push the input means out of the receptacle, and the user can easily take the input means out of the receptacle. This secure placement of the input means has proven particularly convenient.

A further advantageous embodiment is characterized in that the input means is arranged on a key ring and the key ring is placed in an opening in the housing. In order to prevent loss of the mobile identification transmitter, this can have a key ring to which the automobile manufacturer's logo is attached. Such a type of key ring generally consists of twice-wound circular wire that has a certain spring tension. Thus pendants or other mechanical keys can be put on the key ring and held there securely. To connect the mobile identification transmitter with the key ring, an opening can be arranged on the former, which is bridged by a clasp similar to a snap link whereby a reversible taking out and putting on of the key ring is possible. Preferably, the clasp similar to a snap link has a spring-loaded fastening bolt that can be pushed in the direction of the opening in order to take out the key ring on which the input means is moveably or fixedly arranged. Preferably, the input means is a key pendant that is connected to the key ring. In this arrangement the input means is nearly unable to become lost, and yet easy for a potential user to reach.

The mobile identification transmitter of the invention can be used in a so-called keyless-go system for a motor vehicle. For reasons of security it has proven advantageous for the housing of the mobile identification transmitter to have a key case and for the key case to store an emergency key. The emergency key is for the activation of a mechanical lock of the motor vehicle and is reversibly removable from the key case. The basis for the above-described use of an emergency key is any reservation with respect to the security and reliability of electronic systems. Consequently, modern motor vehicles still have a mechanical lock that can be opened and locked by an emergency key as a redundancy measure. In order to store the mechanical key so that it is nearly unable to be lost and always accessible, it has proven advantageous to integrate the emergency key into the housing of the mobile identification transmitter. In addition, in a further embodiment the input means can be arranged on the emergency key. Preferably, the input means and the emergency key are thus in one piece.

In order to be functional, the emergency key has a handle area and a bit element. The bit element serves for clear identification of the emergency key vis-à-vis the mechanical lock, while the handle area serves for the rotational activation of the emergency key. In a first advantageous variant the input means is arranged on the bit element. The position of the input means depends on the formation of the bit element. Therefore, the bit element can consist on one hand of an oblong segment provided with a somewhat rectangular cross-section, on the side flanks of which characteristic indentations are made. In this case it is advantageous for the input means to be arranged on one of the flat upper or undersides of the bit element. On the other hand, the bit element has a characteristic bottom area, in part of which deeper notches are made. The bit element also often runs into a triangular tapering bit tip. With such a type of emergency key, it is advantageous to integrate the input means into the bit tip. This allows the emergency key to be used as a pen.

In a second variant the input means can be arranged on the handle area of the emergency key. Generally, the latter area has a somewhat rectangular exterior shape in order to achieve easy handling of the emergency key. In one possible embodiment it is therefore provided that the input means is arranged on a corner region of the handle area. Positioning on one of the side surfaces of the handle area is also conceivable.

A further measure improving the invention anticipates that within the key case an energy storage mechanism is arranged, and the energy storage mechanism, in one position of the emergency key, pushes this out of the key case. As already described for the input means, a locking and counter-locking means can be provided in the key case, which cooperates with the emergency key and secures the reversibly removable storage. The emergency key can be held in a force-fitting and/or form-fitting manner in an engaged position vis-à-vis the energy storage mechanism. With light pressure on the emergency key, the lock connection between the locking and counter-locking means is released, and the energy storage mechanism pushes the emergency key into a removal position, from which the latter can be removed easily by the user.

So that the input means or mobile identification transmitter can be used even at twilight or in darkness, a further advantageous variant provides the input means with a lighting unit. The lighting unit can be arranged in the vicinity of or in the input tip. Advantageously, this lighting unit is an LED or an OLED. Both lighting units are known for their high efficiency and low use of energy. In particular, the organic light-emitting diode (OLED) can be arranged as a foil-like object on the exterior of the input stylus, thereby fully illuminating it.

In a further advantageous embodiment, the mobile identification transmitter has a central memory and/or an interface. By means of this interface it is possible for the mobile identification transmitter to be connected to an external computer and to transmit information. This information can concern various switching states of electric motors, locks, heating and AC systems or sensors inside the vehicle, etc. The interface can also advantageously bring about a connection with a computer of a garage of the motor vehicle dealer, in order to transmit service data or other information critical to a possible repair of the motor vehicle. In this connection it has proven advantageous for the interface to have one of the following standards: Infrared, Bluetooth, WLAN, USB, RS232 or RS485.

### BRIEF DESCRIPTION OF THE DRAWINGS

Further advantages, features and details of the invention emerge from the following description, in which several possible embodiments of the invention are described in detail with reference to the drawings. Therein, the features mentioned in the claims and in the description respectively are essential to the invention either singly or in any combination. These are:

FIG. 1—a purely schematic representation of a mobile identification transmitter that is in data communication with a locking device of a motor vehicle,

FIG. 2—a housing of the mobile identification transmitter and an emergency key, in a three-dimensional view,

FIG. 3—a further embodiment of the emergency key,

FIG. 4—a further advantageous variant of the emergency key and

FIG. 5—the housing of the mobile identification transmitter and an input stylus.

### DETAILED DESCRIPTION OF THE INVENTION

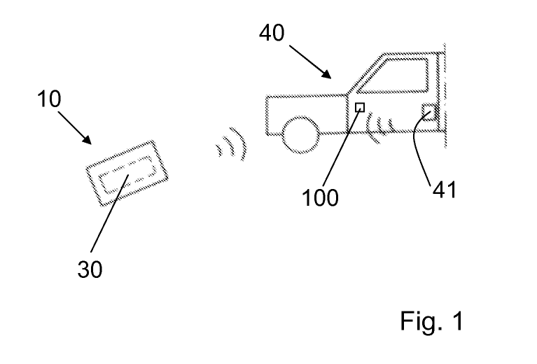

In FIG. 1 a mobile identification transmitter 10 is represented in purely schematic manner, in communication with a transmitting and receiving unit 41 of a motor vehicle 40. The mobile identification transmitter 10 has, among other things, an electronic unit that is provided with a battery as energy storage.

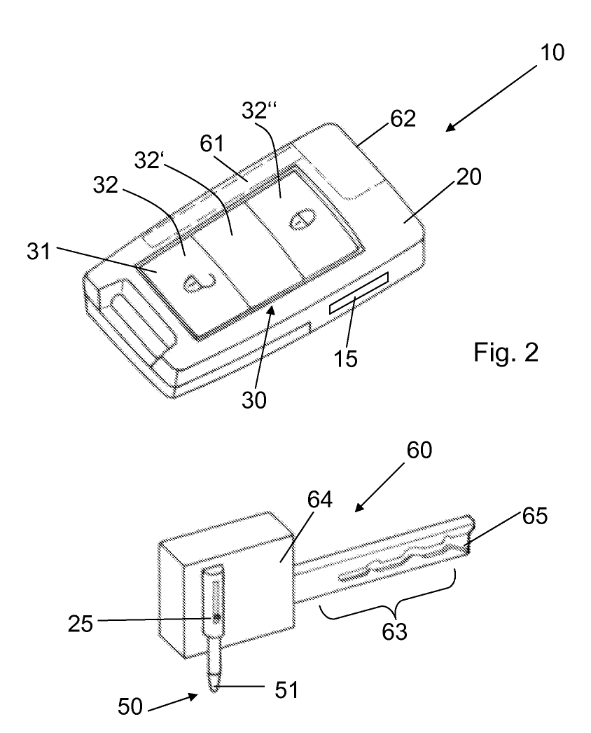

In FIG. 2 the rectangular mobile identification transmitter 10 is shown. This has a housing 20, on the upper side of which a sensor display 30 is inlaid. The mobile identification transmitter 10 is used primarily to transmit instructions to the security system of the motor vehicle 40. Thus primarily the locking and unlocking of a locking device 100 of the motor vehicle 40 is controlled. It is also conceivable, however, for information about the motor vehicle—such as the temperature or the lighting status of the vehicle—to be transmitted to the mobile identification transmitter 10. The sensor display 30 makes it possible to display these different items of information. For instance, in FIG. 2 the sensor display 30 is divided into three input areas 32, 32′, 32″. By touching the sensor display 30 in one of the input areas 32, 32′, 32″ the mobile identification transmitter 10 can be activated. As an example, this will be described for the locking and unlocking of the locking device 100 of the motor vehicle 40. The input area 32″ shows the symbol of a closed lock. When the sensor display 30 is touched in this input area 32″, the mobile identification transmitter 10 sends a lock signal to the locking device 100 of the motor vehicle 40, which results in locking. According to the invention, communication can take place between the motor vehicle 40 and the mobile identification transmitter 10 after a successful locking, which results in a change of the color underlying the input area 32″. Thus, visual verification by the user of successful locking is possible. When the user wishes to unlock the motor vehicle 40 again, it is necessary only to press on the input area 32, in which the symbol of an opened lock is reproduced. By means of the touch and location sensitive surface 31, it is possible for the sensor display 30 to determine the point of contact.

Further, the mobile identification transmitter 10 has an interface 15. This interface 15 functions to transmit information to an external computer. Thus, service data or other necessary data for possible repair of the motor vehicle 40 are transmitted to a computer in a garage.

For purposes of redundancy, the mobile identification transmitter 10 has an emergency key 60. This emergency key 60 is held inside the key case 61, which is integrated into the housing 20. The emergency key 60 functions to lock and unlock a mechanical lock arranged in the motor vehicle 40. The emergency key 60 has a bit element 63 and a handle element 64. The bit element 63 serves for identification of the emergency key 60 vis-à-vis the mechanical lock, for which an identification structure 65 is put into the bit element 63.

Because of the large number of sensors and control devices that are integrated into the motor vehicle 40 and communicate with the mobile identification transmitter 10, a large number of different symbols are displayed on the sensor display 30. The object of precise control of the different input areas 32, 32′, 32″ that underlies the invention is attained by an input means 50. Said input means 50 serves to input information or directions into the sensor display 30, which are to be transmitted by means of the mobile identification transmitter 10 to the motor vehicle 40. In the variant represented in FIG. 2, the input means 50 can be arranged on the handle area 64 of the emergency key 60. The input means 50 is cylindrical and has a spherically tapering input tip 51. By means of this input tip 51 a user can touch the sensor display 30 and thus input precise information and/or commands into the mobile identification transmitter 10. The cylindrical input means 50 is stored in a receptacle 25. The receptacle 25 is placed on the rectangular handle area 64 of the emergency key 60. The receptacle is casing-like and has an oblong gap through which an activator juts. This activator is connected to the input means 50 and allows a reversible displacement of the input means 50.

The emergency key 60 can be inserted into the key case 61 through an opening 62 in the housing 20. According to the invention, it is provided that an energy storage mechanism, in particular a spring, is arranged in the key case 61 and comes in contact with the emergency key. When the emergency key 60 is pushed into the key case 61, a locking means arranged there holds the emergency key 60 in position. When a user wishes to remove the emergency key from the housing 20, a short pressure is necessary, which transfers the emergency key to a position in which the locking means is no longer in engagement with the emergency key 61. Then the energy storage mechanism can push the emergency key 60 out of the key case 61.

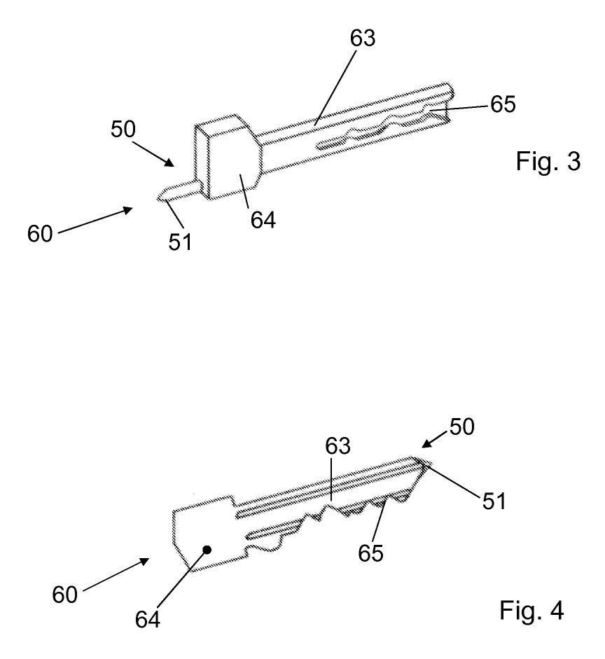

In FIG. 3 a further possible arrangement of the input means on the handle area 64 of the emergency key 60 is represented. In this variant the input means 50 lies not on a cross side of the handle area 64, but on one of the longitudinal sides. This results in a long extended narrow emergency key 60, which can also be integrated into a small-scale mobile identification transmitter 10.

The emergency keys 60 represented in FIGS. 2 and 3 have a bit element 63 whose identification structure 65 is put into one of the longitudinal sides of the bit element 63. In contrast, the emergency key 60 represented in FIG. 4 is provided with an identification structure 65, which is put into the under side of the bit element 63 in the form of an indentation. Such a type of emergency key 60 often has a triangular tip. According to the invention, it is provided that this tip be formed as an input means 50. In the example shown, the input means 50 has an input tip 51 that can be used for the input of information into the sensor display 30.

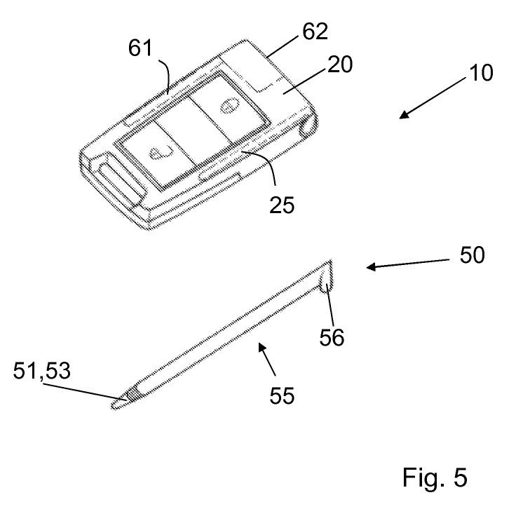

In FIG. 5 a further variant of the mobile identification transmitter 10 is represented. In this, the input means 50 is formed separately and not connected with the emergency key. Rather, the input means 50 is an input stylus 55, which has a soft plastic core 53 that is formed into an input tip 51. So that the input stylus 55 is easy to use, it has a hard surface that is easy to grip. Preferably, the surface is made of a plastic and injected around the soft plastic core 53. For storing the input stylus 55, a receptacle 25 is placed on the housing 20. This receptacle 25 is constructed as a casing and has an opening through which the input stylus 55 can be inserted. As indicated, the input stylus 55 has an L-shaped end 56 that juts out of the housing 20 through a lateral opening in the receptacle 25. Thus a user can easily remove the input stylus 55 from the receptacle 25 and input information precisely into the sensor display 30.

1. A mobile identification transmitter of a security system for keyless activation of a locking device of a motor vehicle, comprising:
a housing and
a sensor display,
wherein in the housing an electronic unit with a transmitting and receiving unit is arranged, which is in communication with a transmitting and receiving unit in the motor vehicle, by which an identification check to establish a user's authorization can be carried out,
wherein a surface of the sensor display serves for input on one side and for output on the other side of information, and
wherein the mobile identification transmitter has a stylus-like input means, wherein the input means serves to input information.

2. The mobile identification transmitter of claim 1, wherein the input means has an input tip, and contact between the sensor display and the input tip enables the input of information.

3. The mobile identification transmitter of claim 2, wherein the input means is an input stylus with a soft plastic core, wherein the shaft of the input stylus is hard and easy to grip, and the soft plastic core forms the input tip.

4. The mobile identification transmitter of claim 3, wherein the input means is stored in a receptacle and the receptacle is fashioned like a casing and the input stylus lies in the casing-like receptacle.

5. The mobile identification transmitter of claim 4, wherein the receptacle is arranged in the housing, wherein the input stylus is reversibly removable from the receptacle.

6. The mobile identification transmitter of claim 4, wherein an energy storage mechanism on the input means is arranged inside the receptacle, and the energy storage mechanism in one position of the input means pushes the input means out of the receptacle.

7. The mobile identification transmitter of claim 1, wherein the input means is arranged on a key ring, and the key ring lies in an opening in the housing.

8. The mobile identification transmitter of claim 1, wherein the housing has a key case and the key case stores an emergency key, wherein the emergency key functions to activate a mechanical lock of the motor vehicle and is reversibly removable from the key case.

9. The mobile identification transmitter of claim 8, wherein the input means is arranged on the emergency key and the input means and emergency key are in one piece.

10. The mobile identification transmitter of claim 9, wherein the emergency key has a bit element and the input means is arranged on the bit element.

11. The mobile identification transmitter of claim 9, wherein the emergency key has a handle area, and the input means is arranged on the handle area and wherein the input means is arranged on an edge region of the handle area.

12. The mobile identification transmitter of claim 8, wherein an energy storage mechanism inside the key case is arranged on the emergency key, and the energy storage mechanism in one position of the emergency key pushes the emergency key out of the key case.

13. The mobile identification transmitter of claim 1, wherein the input means has a lighting unit comprising an LED or an OLED.

14. The mobile identification transmitter of claim 1, wherein the mobile identification transmitter has a central memory and/or an interface, wherein the mobile identification transmitter can be connected with an external computer via the interface, and wherein the interface has one of the following standards: Infrared, Bluetooth, W-LAN, USB, RS 232 of RS 485.
